(19) United States
(12) Patent Application Publication
(10) Pub. No.: US 2006/0232239 A1
(43) Pub. Date: Oct. 19, 2006

(54) Flashlight charger with an improved contact

(75) Inventors: Anthony Maglica, Ontario, CA (US); Stacey H. West, Upland, CA (US)

Correspondence Address: JONES DAY, 555 SOUTH FLOWER STREET FIFTIETH FLOOR, LOS ANGELES, CA, 90071, US

(73) Assignee: Mag Instrument, Inc.

(21) Appl. No.: 11/108,520

(22) Filed: Apr. 18, 2005

(51) Int. Cl. H02J 7/00

(52) U.S. Cl. 320/107

(57) ABSTRACT

A charger is provided that includes an improved contact for holding a flashlight and electrically connecting to a charging contact of the flashlight. The charger includes an area for receiving the head of a flashlight, and an area for receiving the barrel of a flashlight. The contact is disposed about the area for receiving the barrel. The contact is deflectable and includes portions that expand and mate with the charging contact of the flashlight to hold the flashlight in place while electrically connecting to the charging contact for supplying electrical energy to a rechargeable battery contained in the flashlight.

### BACKGROUND OF THE INVENTION

The field of the present invention is flashlight chargers. More particularly, the invention is directed to a flashlight charger for charging a chargeable source of energy contained in a flashlight.

Electronic devices containing rechargeable batteries have grown in popularity over the years. Typically, when a rechargeable battery is drained of its electrical charge, the user removes the battery from the electronic device for recharging in a charger specifically designed for that battery type and size.

An improvement over the typical charger mentioned above is a device that charges the batteries without the need to remove the batteries from the electronic device. Such a charger is described in U.S. Pat. No. 4,388,673, by Anthony Maglica, which is hereby incorporated by reference. This patent describes a flashlight including an annular flange and an annular contact member adapted to be placed in electrical contact with contact members of a battery charger. The battery charger includes a spring loaded arcuate flange to hold the flashlight into the charger. Separate charger contact points are provided for making electrical contact with the flashlight's annular flange and annular contact members. Although charging batteries contained in an electronic device is achieved in this manner, alternate means for charging the batteries continue to be desirable.

Accordingly, it is an object of the invention to provide an improved flashlight charger.

### SUMMARY OF THE INVENTION

In a first aspect of the invention, a charger is configured to electrically charge a chargeable source of energy contained in a flashlight. The charger includes a support to receive the flashlight, and an electrical contact that is configured to mate with a charging contact on the flashlight and to hold the flashlight in the support while the portable source of energy is charged through the electrical contact. The electrical contact may be a spring contact formed from a strip of conductive material. The spring contact may include an expandable C-shaped clip having a curved spring at an end. The charger may also include a charging circuit coupled to the electrical contact to apply a constant current to the chargeable source of energy for a first time period and to apply a constant voltage to the chargeable source of energy for a second time period.

In a second aspect of the invention, a charger includes a receptacle with a curvilinear surface that defines an open cavity. The charger also includes a deflectable conductor that has at least a portion that is biased towards the cavity of the receptacle to restrain the flashlight in the receptacle, and that is suitable to mate with a charging contact on the flashlight and conduct energy thereto. The open cavity of the receptacle may extend longitudinally. The deflectable conductor may be a spring contact that has an expandable C-shaped clip.

In a third aspect of the invention, a charger includes a cradle including multiple regions to receive portions of a flashlight. The charger also includes a contact member configured to electrically connect to a charging contact of a flashlight and hold the flashlight in the cradle. Where the contact member is an expandable spring formed from a strip of conductive material with each end of the strip folded back to create a curved spring. Each curved spring serving to hold the flashlight in the cradle.

Accordingly, an object of the present invention to provide a charger with an improved contact for holding a flashlight and charging a rechargeable source of energy contained in the flashlight.

### BRIEF DESCRIPTION OF THE DRAWINGS

Other objects and features will become apparent from the following detailed description taken in combination with the accompanying drawings. However, the drawings are provided for purposes of illustration only, and are not intended as a definition of the limits of the invention.

In the drawings, wherein the same reference number indicates the same element throughout the several views:

FIG. 1 is a top view of the present flashlight and charger.

FIG. 2 is a perspective view of the charger of FIG. 1.

FIG. 3 is a top view of the charger of FIG. 1.

FIG. 4 is a cross-section of the charger taken along plane 4-4 of FIG. 3.

FIG. 5 is a cross-section of the flashlight-charger of FIG. 1 taken along plane 5-5 of FIG. 1.

FIG. 6 is a circuit diagram of a charging circuit of the charger of FIG. 1.

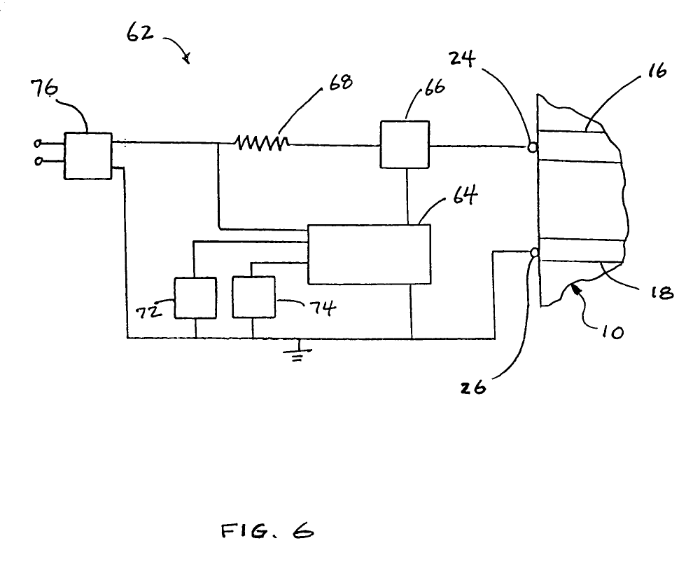

FIG. 7 is a perspective view of an alternate version of a charger in accordance with the present invention.

### DETAILED DESCRIPTION OF THE PREFERRED EMBODIMENT

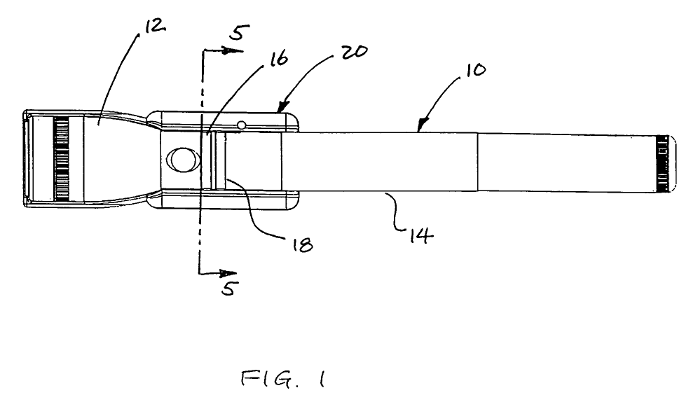

Turning now in detail to the drawings, as shown in FIG. 1, a flashlight 10 is received in charger 20. The flashlight 10 includes a chargeable or rechargeable source of energy contained therein (not shown). The chargeable source of energy may be a rechargeable battery, a high capacity storage capacitor, or other suitable source of energy. Preferably, the chargeable source of energy is a rechargeable battery. The flashlight 10 includes a head 12, a barrel 14, a first charging contact 16 and a second charging contact 18. The first and second charging contacts 16, 18 are coupled to the rechargeable batteries. The first and second charging contacts 16, 18 are annular and extend circumferentially around the barrel 14 of the flashlight 10. However, alternative type charging contacts which do not extend circumferentially around the barrel could also be used.

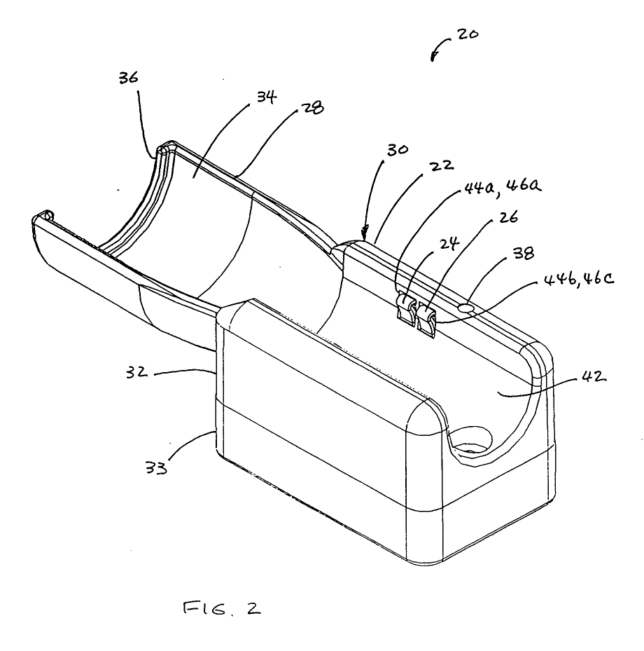

The charger 20 is adapted to receive at least a portion of the flashlight 10 as shown in FIG. 1. Referring to FIG. 2, the charger 20 includes a support 22, a first electrical contact 24 and a second electrical contact 26. In a preferred embodiment, the support 22 of the charger 20 includes a head section 28 and a base assembly 30. The head section 28 is adapted to receive the head 12 of the flashlight 10, and includes a head receiving area 34 and a flange 36. The head receiving area 34 is an open cavity defined by a curvilinear surface. In the illustrated embodiment, the head receiving area 34 is formed in a shape that generally corresponds to the shape of the head 12 of the flashlight 10. The flange 36 is disposed on the forward end of the head receiving area 34 and serves to restrain the flashlight 10.

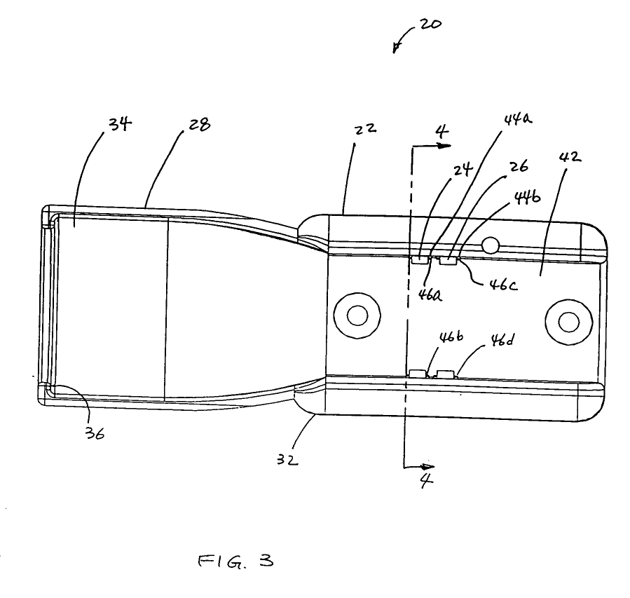

Referring to FIGS. 2 through 4, the base assembly 30 is disposed adjacent to the head section 28. The base assembly 30 includes an upper base 32, a lower base 33, and holds the first and second electrical contacts 24, 26, a light emitting diode (LED) display 38, and a charging circuit 62 (not shown). The upper base 32 includes a barrel receiving area 42, two internal slots 44a, 44b and, four openings 46a, 46b, 46c, 46d. The barrel receiving area 42 is adapted to receive at least a portion of the barrel 14 of the flashlight 10. In a preferred embodiment, the barrel receiving area 42 is an open cavity defined by a curvilinear surface that extends longitudinally. Each of the internal slots 44a, 44b is adapted to receive the first and second electrical contacts 24, 26, respectively. The slots 44a, 44b are disposed parallel to each other, and each breaks through the barrel receiving area 42 at two places to define the four openings 46a, 46b, 46c, 46d. Referring to FIG. 3, the first electrical contact 24 fits into internal slot 44a and extends through openings 46a, 46b. The second electrical contact 26 fits into internal slot 44b and extends through openings 46c, 46d.

Each of the first and second electrical contacts 24, 26 has a dual function of holding the flashlight 10 in the charger 20, and conducting energy to a rechargeable battery contained in the flashlight 10. In a preferred embodiment, the first and second electrical contacts 24, 26 have identical features, and slots 44a and 44b have identical features. Accordingly, the description of the first electrical contact 24 and slot 44a that is to follow also applies to the second electrical contact 26 and slot 44b, respectively. However, it is expressly noted here that identity of the electrical contacts 24, 26 or the internal slots 44a, 44b is not required to practice the present invention as described herein.

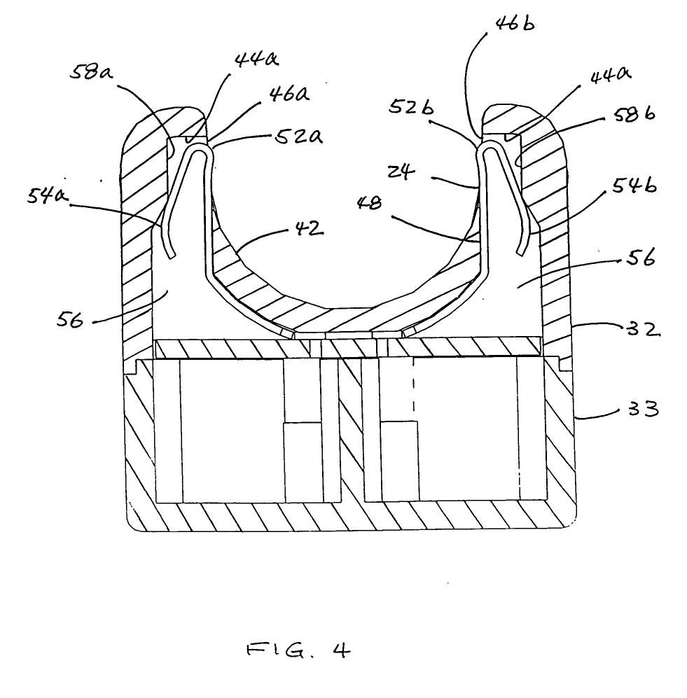

Referring to FIG. 4, the first electrical contact 24 includes an expandable C-shaped clip portion 48, rounded ends 52a, 52b, and curved springs 54a, 54b. The C-shaped clip portion 48 fits into the internal slot 44a and is sized to mate with the first charging contact 16 of the flashlight 10. Each end of the first electrical contact 24 is formed to bend toward the cavity defined by the barrel receiving area 42, and then folded in a direction away from the barrel receiving area 42 to define the rounded ends 52a, 52b and curved springs 54a, 54b.

In a preferred embodiment, the first electrical contact 24 is made from a strip of conductive material, such as for example, phosphor bronze or other suitable material.

Still referring to FIG. 4, the internal slot 44a is configured to receive the first electrical contact 24, and includes a cavity 56 and sidewalls 58a, 58b. The C-shaped clip portion 48 of the first electrical contact 42 fits into the cavity 56 and the rounded ends 52a, 52b extend through openings 46a, 46b, respectively. The curved springs 54a, 54b bear against sidewall 58a, 58b, respectively. The lower base 33 is secured to the upper base 32 and further serves to contain the first electrical contact 24 in slot 44a.

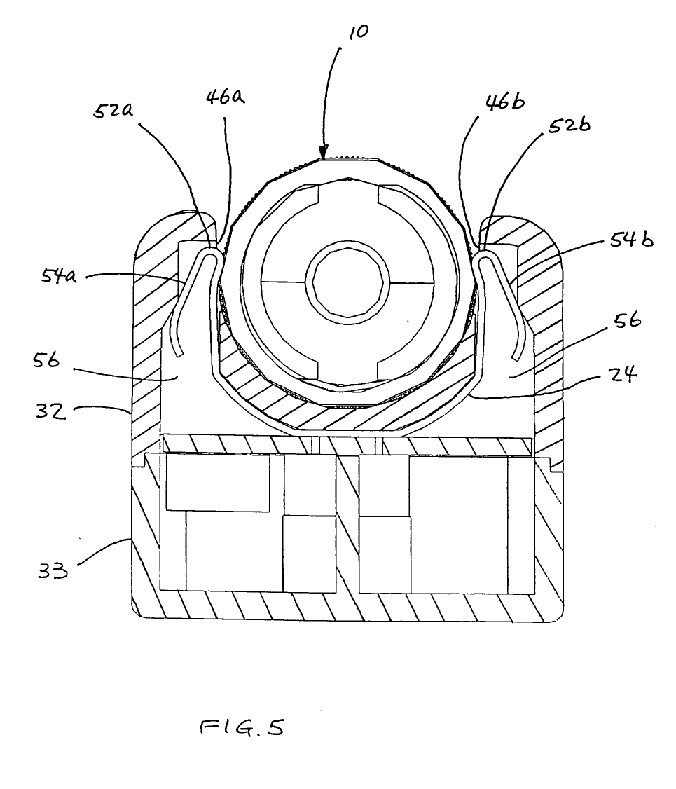

Referring to FIG. 5, the flashlight 10 is installed into the charger 20 by positioning it over the rounded ends 52a, 52b that extend towards one another through openings 46a, 46b. By applying sufficient downward force on the flashlight 10, the rounded ends 52a, 52b deflect away from each other and the curved springs 54a, 54b compress. When the flashlight 10 is displaced further downward until it rests against the barrel receiving area 42, the curved springs 54a, 54b will bias the rounded ends 52a, 52b back towards each other to hold or clamp the flashlight 10 in the support 22. The shape of the head receiving area 34 guides the head 12 of the flashlight 10 therein. The flange 36 of the head section 28 limits the forward axial displacement of the flashlight 10 relative to the charger 20. By properly positioning the first electrical contact 24 relative to the head receiving area 34, the first electrical contact 24 is aligned to make an electrical connection with the first charging contact 16 of the flashlight 10. To remove the flashlight 10 from the charger 20, the user applies an upward force to expand the C-shaped clip portion 48, and displacing the rounded ends 52a, 52b to deflect away from each other.

The clamping or holding force from the curved springs 54a, 54b advantageously enhance the connection between the first electrical contact 24 and the first charging contact 16. Also, the rubbing action between the flashlight 10 and the first electrical contact 24 during the flashlight installation/removal sequence advantageously removes oxidation or other foreign matter that may be on the electrical contact 24 to further enhance the electrical connection.

The second electrical contact 26 is positioned relative to the head receiving area 34 of the charger to align and mate with the second charging contact 18 of the flashlight 10. Having the second electrical contact 26 configured and arranged in a similar manner as described above for the first electrical contact 24 serves to increase the ability of the charger 20 to hold the flashlight 10 in place.

Although the disclosed electrical contacts 24, 26 each includes a pair of curved springs, the present invention is not limited to a specific type of spring or the number of springs. For example, a single spring may be adapted to supply sufficient force to hold the flashlight and maintain electrical contact with the flashlight's charging contact. Also, the spring may be a coil spring that is adequately constrained to provide the holding force while making electrical contact with the flashlight's charging contact. However, the two curved springs as disclosed herein advantageously provides a balanced and effective means to hold the flashlight in the charger 20.

Also, although the charger configuration disclosed herein includes first and second electrical contacts 24, 26 that each extend partially out from openings 46a, 46b, 46c, 46d, the present invention is not limited to such an arrangement. The present invention may be practiced without any openings 46a, 46b, 46c, 46d, and with one or both electrical contacts completely exposed and arranged on top of the barrel receiving area 42. However, having the expandable electrical contacts disposed in an internal cavity as disclosed herein provides a securely contained contact that effectively holds the flashlight 10 in the charger while electrically connecting to the flashlight's charging contacts.

Thus, the first and second electrical contacts 24, 26 are provided that makes contact with the first and second charging contacts 16, 18, and that retains the flashlight 10 in the charger 20. A charging circuit 62 controls the charging operation of the rechargeable batteries. The charging operation may consist of providing a constant charging current for a fixed or variable period of time followed by an application of a constant voltage for a fixed or variable period of time. In a preferred embodiment, the charging circuit 62 provides a constant charging current to the rechargeable batteries until a transition voltage is reached. Once the transition voltage is reached, the constant voltage is applied across the rechargeable batteries until the charging current tapers to zero. For a Lithium-Ion rechargeable battery, the transition voltage is typically 4.2 Volts per cell.

Referring to FIG. 5, the charging circuit 62 includes an integrated circuit 64, a metal oxide semiconductor field effect transistor (MOSFET) 66, a current sense resistor 68, a red LED 72, a green LED 74 and a power connection 76. The integrated circuit 64 is connected to the MOSFET 66 to control the flow of energy from a DC power supply to the rechargeable batteries contained in flashlight 10. Through the use of the sense resistor 68, the integrated circuit 64 can monitor the current flowing to the rechargeable batteries and the voltage level across the rechargeable batteries. With this information, the integrated circuit 64 is able to control the MOSFET 66 to implement and manage the preferred charge algorithm as described above.

The charging circuit 62, through power connection 76, may be electrically connected to any suitable source of electrical power. For example, the power connection 76 may be coupled to a DC wall adapter through an electrical coil.

The integrated circuit 64 is also coupled to the red LED 72 and green LED 74 to provide a visual indication of the charging status. In a preferred embodiment, activating the red LED 72 indicates to the user that charging is in process; and activating the green LED 74 indicates that the charging is complete. Further, if the flashlight 10 is not installed into the charger 20, the green LED 74 is activated to indicate that the charger 20 is ready to charge.

Although the preferred charging circuit 62 includes the integrated circuit 64 to manage the charging operation, other suitable devices, such as a microprocessor or microcomputer may also be used. Similarly, a transistor or other suitable power controlling device may be used in place of a MOSFET.

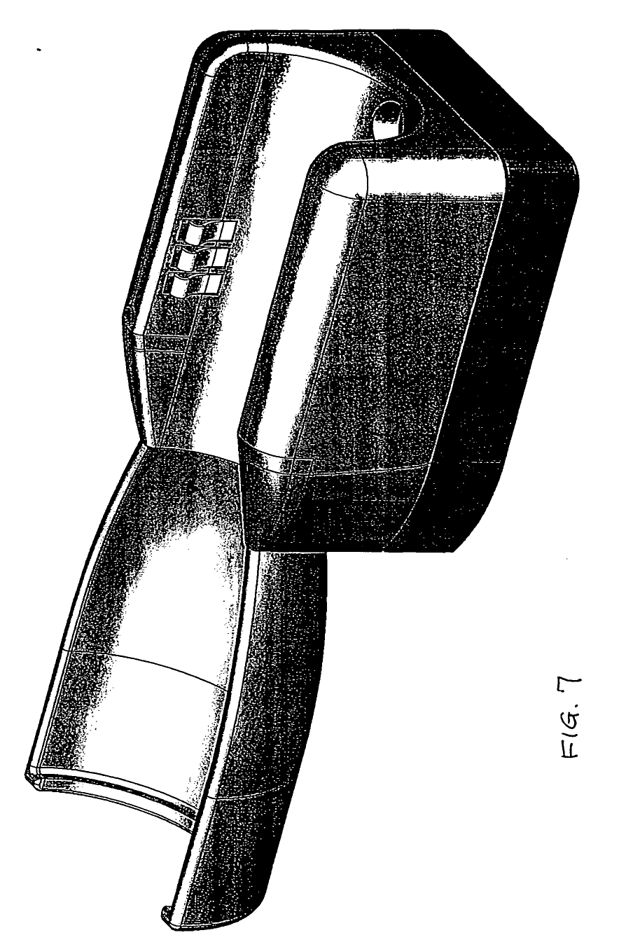

Also, although the illustrated charging circuit 62 couples to two electrical contacts 24, 26, the charging circuit 62 may also be configured to connect to a third electrical contact for receiving information, for example, about the type of source of energy or the number of cells that are contained in the flashlight 10. Such information may be used to select and apply the proper charge algorithm. This third electrical contact may also be used for receiving charging information during the charging process for monitoring. In such an embodiment, the third electrical contact is preferably configured in a similar manner as described above for the first and second electrical contacts 24, 26. The third electrical contact may be arranged in parallel to the first and second electrical contacts 24, 26, as shown in FIG. 7.

Further, although a Lithium-Ion rechargeable battery is recited above, the present invention is not limited by the type of rechargeable battery that may be contained in the flashlight 10. Other rechargeable sources such as Nickel Cadmium battery, Nickel Metal Hydride battery, sealed lead acid battery or sources having other suitable chemistry may also be used. A charging algorithm most appropriate to effectively charge the selected rechargeable source may be managed by the integrated circuit 64 or by other suitable managing device.

In a preferred embodiment, the charging circuit 62 is on a circuit board. The circuit board may be housed in the base assembly 30, and electrically connected to the first and second electrical contacts 24, 26 . The red and green LEDs 72, 74 can be disposed near the LED display 38 such that the LED indication is visible to the user.

Thus, a novel charger with an improved contact has been shown and described. Various changes can, of course, be made without departing from the spirit and scope of the invention. The invention, therefore, should not be restricted except to the following claims and their equivalents.

What is claimed is:

1. A charger configured to electrically charge a chargeable source of energy contained in a flashlight, said charger comprising:
a support configured to receive the flashlight; and
a first electrical contact held by the support, the first electrical contact configured to mate with a first charging contact on the flashlight and to hold the flashlight in the support while the portable source of energy is charged through the first electrical contact.

2. A charger of claim 1, wherein said support includes a first receiving area adapted to receive a barrel of the flashlight and a second receiving area adapted to receive a head of the flashlight.

3. A charger of claim 2, wherein the first electrical contact is disposed in the first receiving area of the support.

4. A charger of claim 2, wherein the second receiving area has a surface that is formed in a shape generally corresponding to the shape of the head of the flashlight.

5. A charger of claim 1, wherein the first electrical contact is a spring contact formed from a strip of conductive material.

6. A charger of claim 5, wherein the spring contact includes an expandable C-shaped clip configured to removably hold the flashlight in the support.

7. A charger of claim 6, wherein the spring contact further includes first and second curved spring portions extending from first and second ends of the C-shaped clip, respectively, and which bias the first and second ends toward one another.

8. A charger of claim 6, wherein an end of the C-shaped clip is folded back to create a curved spring.

9. A charger of claim 5 further including a second electrical contact held by the support and adapted to mate with a second charging contact on the flashlight, wherein the second electrical contact is a spring contact including an expandable C-shaped clip region configured to removably hold the flashlight in the support.

10. A charger of claim 1 further including a charging circuit coupled to the first electrical contact, the charging circuit configured to apply a constant current to the chargeable source of energy for a first time period and to apply a constant voltage to the chargeable source of energy for a second time period.

11. A charger of claim 10, wherein the charging circuit includes an integrated circuit.

12. A charger for a flashlight comprising:
a receptacle including a curvilinear surface that defines an open cavity; and
a first deflectable conductor held by the receptacle and disposed about the curvilinear surface, wherein at least a portion of the first deflectable conductor is biased towards the cavity of the receptacle to restrain the flashlight in the receptacle, and wherein the first deflectable conductor is suitable to mate with a charging contact on the flashlight and conduct energy thereto.

13. A charger of claim 12, wherein the open cavity of the receptacle extends longitudinally.

14. A charger of claim 12, wherein the first deflectable conductor is a spring contact formed from a strip of conductive material.

15. A charger of claim 14, wherein the spring contact includes an expandable C-shaped clip configured to removably hold the flashlight in the receptacle.

16. A charger of claim 15, wherein the spring contact further includes first and second curved spring portions extending from first and second ends of the C-shaped clip, respectively, and which bias the first and second ends toward one another.

17. A charger of claim 15, wherein an end of the C-shaped clip is folded back to create a curved spring.

18. A charger of claim 12, wherein said first deflectable conductor is biased towards the cavity of the receptacle at two places.

19. A charger of claim 12, wherein said first deflectable conductor is bronze.

20. A charger of claim 12 further including a second deflectable conductor held by the receptacle.

21. A charger comprising.
a cradle including a first region and a second region adjacent to the first region, the first region configured to receive a first portion of a flashlight, the second region configured to receive a second portion of the flashlight; and
a contact member disposed about said first region of the cradle, wherein the contact member is configured to electrically connect to a charging contact of a flashlight and hold the flashlight in the cradle, wherein the contact member is an expandable spring formed from a strip of conductive material with each end of the strip folded back to create a curved spring, each curved spring serving to hold the flashlight in the cradle.

22. A charger of claim 21, wherein the second portion of the flashlight is the head of the flashlight.

23. A charger of claim 21, wherein the first region of the cradle is generally defined by half of a cylinder.

24. A charger of claim 21, wherein the first region of the cradle includes a cavity, wherein the curved springs are biased toward the cavity of the cradle.

25. A charger of claim 21, wherein the contact member electrically couples to the charging contact of the flashlight to charge a portable source of energy contained in the flashlight.

26. A charger of claim 21, wherein the contact member is bronze.

27. A charger comprising:
housing means for receiving a flashlight containing a chargeable source of energy; and
means for holding the flashlight within the housing means and for charging the chargeable source of energy contained in the flashlight.
